(19) United States
(12) Patent Application Publication
(10) Pub. No.: US 2015/0348735 A1
(43) Pub. Date: Dec. 3, 2015

(54) METHOD OF MANUFACTURING FLUORESCENT LAMP AND FLUORESCENT LAMP MANUFACTURED USING THE SAME

(71) Applicant: Seong Jin KANG, Seongbuk-gu Seoul (KR)

(72) Inventors: Seong Jin Kang, Seoul (KR); Seong Seok Kang, Seoul (KR)

(21) Appl. No.: 14/386,469

(22) PCT Filed: Mar. 21, 2013
(86) PCT No.: PCT/KR2013/002324

§ 371 Date: Sep. 19, 2014

(30) Foreign Application Priority Data
Mar. 21, 2012 (KR) 10-2012-0028665

(51) Int. Cl. H01J 9/32; H01J 9/395; H01J 9/385; H01J 19/58; H01J 19/62

(52) U.S. Cl. CPC H01J 9/326; H01J 19/58; H01J 19/62; H01J 9/385; H01J 9/395

(57) ABSTRACT

Disclosed herein are a method of manufacturing a fluorescent lamp and a fluorescent lamp manufactured using the same. The method includes preparing a flare having an upper surface that corresponds to a cross-sectional area of a glass tube of the lamp, manufacturing a stem by forming a lead-in wire and an exhaust tube that pass from a lower surface of the flare to the upper surface thereof and connecting a filament to the lead-in wire of the stem, and melting a circumference of the upper surface of the flare of the stem, introducing the filament into the glass tube via an opening thereof, and contact sealing the upper surface of the flare to an end of the glass tube in such a way that the stem is located outside the glass tube.

### REFERENCE TO RELATED APPLICATIONS

This application is a U.S. National Phase application of International Application No. PCT/KR2013/002324, filed on Mar. 21, 2013, which designates the United States and claims priority of Korean Patent Application No. 10-2012-0028665, filed on Mar. 21, 2012, the entire contents of which are incorporated herein by reference.

### FIELD OF THE INVENTION

The present invention relates, in general, to a method of manufacturing a fluorescent lamp and a fluorescent lamp manufactured using the same and, more particularly, to a method of manufacturing a fluorescent lamp and a fluorescent lamp manufactured using the same, which proposes a novel structure for a stem supporting a filament in the fluorescent lamp, thus achieving the easy formation of a general fluorescent lamp as well as a full spiral type fluorescent lamp or a short leg half spiral type fluorescent lamp that is 8 mm or less in its straight portion for receiving the filament.

### BACKGROUND OF THE INVENTION

Fluorescent lamps were developed by Inman of GE Company in 1938 and are widely used today as a main light source for interior illumination. Meanwhile, many efforts have been made to improve efficiency and color rendition of the fluorescent lamp. The fluorescent lamp is more advantageous in efficiency and lifespan compared to incandescent lamps, so fluorescent lamps are widely used in a variety of fields including the industrial field, the medical field, and the agricultural and fishery field as well as in general illumination of buildings.

Recently, with the demand for energy conservation and miniaturization, a bulb type lamp and a compact type lamp have been developed. The former has become a substitute for incandescent lamps, while the latter has contributed to the reduction in the length of fluorescent lamps by 1̅/̅3̅ or more. Further, as a three wave luminous lamp is developed, miniaturization, lightness, high efficiency, and high color rendition are achieved. Furthermore, in combination with an electronic ballast, high frequency lighting realizes the overall efficiency of a system up to 100 lm/W.

The fluorescent lamp is a kind of gas discharge lamp, and is configured so that ultraviolet rays inherent to mercury atoms are generated using a low-pressure gas discharge, and are radiated to a fluorescent substance applied to an interior of a glass tube, thus exciting the fluorescent substance and emitting visible rays. The fluorescent lamp is configured so that the fluorescent substance is applied to an inner wall of the glass tube, and tungsten electrodes are attached to both ends thereof. Each electrode is filled with an electron emission substance, called an emitter, and the glass tube is filled with an adequate amount of mercury and inert gas, such as argon, of about 2-4 Torr.

FIG. 1 shows a conventional fluorescent lamp. The fluorescent lamp includes a glass tube 30 serving as a light emitting surface, a filament 50 provided in the glass tube 30, a stem 10 disposed to support the filament 50, and a base 70 fixedly mounted to an end of the glass tube 30 to transmit external power to the stem 30.

In the stem 10 are provided a lead-in wire 13 connected to the filament 50 to supply power and an exhaust tube 15 used to create a vacuum in the glass tube 30. The lead-in wire 13 and the exhaust tube 15 are formed to be supported by a flare 11 having the shape of a trumpet tube.

A conventional process of manufacturing the fluorescent lamp will be described below. FIG. 2 shows the conventional process of manufacturing the fluorescent lamp. First, the flare 11, the lead-in wire 13 and the exhaust tube 15 are prepared, and the stem 10 is made such that the lead-in wire 13 and the exhaust tube 15 pass through the flare 11. When the stem 10 is manufactured, in order to fix the lead-in wire 13 and the exhaust tube 15 onto the flare 11, a process of pinch sealing an upper end of the flare 11 is performed. However, due to heat caused by this process, frequently, the exhaust tube 15 may be blocked or the lead-in wire 13 may be broken. Thus, in order to clear the blocked exhaust tube 15, an additional process is required.

After the filament 50 is connected to the lead-in wire 13 of the stem 10 and the stem 10 having the filament 50 is inserted into the glass tube 30, the stem 10 and the glass tube 30 are sealed by melting, so that the stem 10 and the glass tube 30 are coupled to each other.

Further, the glass tube 30 is evacuated via the exhaust tube 15 of the stem 10 to create a vacuum in the glass tube 30. Next, a predetermined gas is injected. Thereafter, a base 70 is assembled to surround the stem 10 through a basing process, so that the fluorescent lamp is finished.

The stem of the conventional fluorescent lamp is designed to be coupled to the discharge glass tube configured in a straight line. For this reason, when the stem is coupled to a curved track of a spiral type lamp that has a rapid increase in demand in recent years, it is almost impossible to precisely position the filament on a central portion of the discharge glass tube, so that it is impossible to implement a substantially full spiral type lamp. Thus, a half spiral type lamp has been proposed, in which a space of 10 to 20 mm or more has a straight-line structure. In the case of a short leg half spiral type lamp having a straight section of 10 mm or less, the lead-in wire to which the filament is connected is bent at a predetermined angle to form a curved structure. In such a half spiral type lamp, an additional process, such as a process of bending the glass tube, is required, and it is difficult to realize automation due to positional precision. In case of bending the lead-in wire at a predetermined angle, a process of positioning the filament on the central portion of the glass tube is required, thus making it difficult to automate the lamp manufacturing process, in addition to deteriorating work efficiency because of a manual operation. Particularly, defective products may frequently occur, in which the filament is in contact a wall of the glass tube, thus incurring serious problems.

### SUMMARY OF THE INVENTION

Accordingly, the present invention has been made keeping in mind the above problems occurring in the prior art, and an object of the present invention is to provide a full spiral type lamp, which solves a problem wherein it is impossible to substantially realize a full spiral type lamp because a straight portion of a predetermined length should be maintained due to a height of a flare inserted into a glass tube in a spiral type lamp, in terms of a configuration of a conventional stem.

Another object of the present invention is to provide a fluorescent lamp, in which a stem is located outside a discharge glass tube to relatively reduce a length of a glass tube while having the same luminous efficiency and thereby use a smaller amount of fluorescent substance in agreement with the reduced length, thus reducing the manufacturing cost of the lamp and decreasing the use of a pollutant.

A further object of the present invention is to provide a method of manufacturing a fluorescent lamp, which solves problems wherein the exhaust tube is blocked or a lead-in wire is cut in a sealing process during a procedure of manufacturing a stem, thus obviating an additional process of clearing the exhaust tube and reducing the number of defective products resulting from the lead-in wire.

In order to accomplish the above objects, the present invention provides a method of manufacturing a fluorescent lamp, including: preparing a flare having an upper surface that corresponds to a cross-sectional area of a glass tube of the lamp; manufacturing a stem by forming a lead-in wire and an exhaust tube that pass from a lower surface of the flare to the upper surface thereof, and connecting a filament to the lead-in wire of the stem; and melting a circumference of the upper surface of the flare of the stem, introducing the filament into the glass tube via an opening thereof, and contact sealing the upper surface of the flare to an end of the glass tube in such a way that the stem is located outside the glass tube.

Preferably, the manufacturing the stem may include: forming the lead-in wire and the exhaust tube in such a way as to pass from the lower surface of the flare to the upper surface thereof; heating and pinch sealing a middle portion of the flare; and connecting the filament to the lead-in wire of the stem.

More preferably, at the preparing the flare, the flare may be manufactured such that a cross-sectional area thereof is reduced for a predetermined length from the upper surface of the flare to a lower end thereof.

Here, at the pinch sealing, after a metal pipe may be inserted into the exhaust tube, the middle portion of the flare may be heated to be pinch sealed.

Alternatively, at the pinch sealing, while gas is injected into the exhaust tube, the middle portion of the flare may be heated to be pinch sealed.

Moreover, the method may further include evacuating the glass tube through exhaust tube to create a vacuum in the glass tube, injecting a predetermined gas, and then assembling a base to surround the stem.

Further, the present invention provides a fluorescent lamp with a stem, including: a flare coupled at an upper surface thereof to an end of a glass tube through contact sealing in such a way that a body of the flare protrudes out from the glass tube; a lead-in wire passing from a lower surface of the flare to an upper surface thereof to support the filament located in the glass tube; and a stem including an exhaust tube that passes from the lower surface of the flare to the upper surface thereof.

Preferably, the fluorescent lamp may further include a base provided to surround the stem.

Here, the fluorescent lamp may be a full spiral type fluorescent lamp or a half spiral type fluorescent lamp.

According to the present invention, it is advantageous in that the flare of the stem is located outside the discharge glass tube, and only the filament and a portion of the lead-in wire for supporting the filament are inserted into the discharge glass tube, thus eliminating a space in the glass tube occupied by the flare and substantially implementing the full spiral type lamp.

Further, it is advantageous in that the stem is located outside the discharge glass tube, thus relatively reducing the length of the glass tube while maintaining the same luminous efficiency and thereby using a smaller amount of fluorescent substance thanks to the reduced length, therefore reducing the manufacturing cost of the lamp and decreasing the use of pollutants.

Moreover, according to the present invention, it is advantageous in that the pinch sealing process of securing the lead-in wire and the exhaust tube to the flare during the procedure of manufacturing the stem is performed on the middle portion of the flare, thus preventing the exhaust tube from being blocked due to the heat of the sealing process and preventing heat of high temperature from being transferred to the lead-in wire and thereby avoiding a problem wherein the lead-in wire is oxidized or cut, therefore obviating the necessity of performing the additional process of clearing the exhaust tube and reducing the number of defective products resulting from the lead-in wire.

### BRIEF DESCRIPTION OF THE DRAWINGS

FIG. 1 is a view showing a conventional fluorescent lamp;

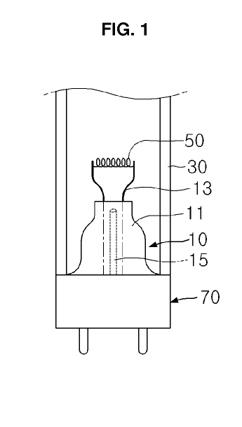

FIG. 2 is a flow diagram showing a conventional process of manufacturing a fluorescent lamp;

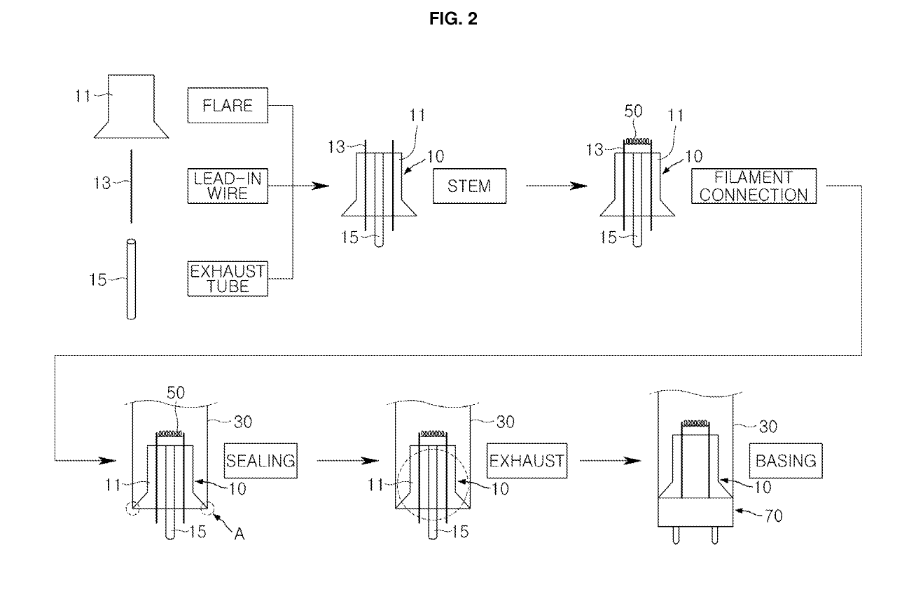

FIG. 3 is a flow diagram showing a process of manufacturing a fluorescent lamp according to an embodiment of the present invention;

FIG. 4 is a view showing a fluorescent lamp according to an embodiment of the present invention;

FIG. 5 is a flow diagram comparing a conventional process of securing an exhaust tube to a flare with a process of securing an exhaust tube to a flare according to an embodiment of the present invention;

FIG. 6 is a flow diagram comparing a conventional process of sealing a glass tube and a stem with a process of sealing a glass tube and a stem according to an embodiment of the present invention;

FIG. 7 is a view comparing a length of a conventional fluorescent lamp with a length of a fluorescent lamp according to an embodiment of the present invention; and

FIG. 8 is a view showing a conventional spiral type fluorescent lamp and a spiral type fluorescent lamp according to an embodiment of the present invention.

### DETAILED DESCRIPTION OF THE INVENTION

The present invention provides a method of manufacturing a fluorescent lamp and a fluorescent lamp manufactured using the same, which proposes a stem of a novel structure, thus being applicable to a general straight type fluorescent lamp and especially a spiral type fluorescent lamp, and thereby implementing a full spiral type fluorescent lamp while simultaneously simplifying and automating a manufacturing process, in addition to reducing the number of defective products.

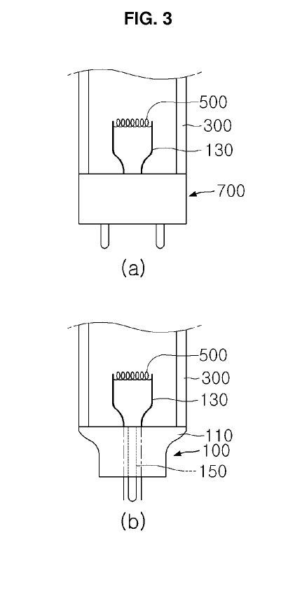

FIG. 3 is a flow diagram showing a process of manufacturing a fluorescent lamp according to an embodiment of the present invention. The method of manufacturing the fluorescent lamp according to the present invention will be described with reference to FIG. 3.

First, a flare 110, a lead-in wire 130 and an exhaust tube 150 are prepared. In this respect, preferably, the flare 110 is formed such that its upper surface corresponds to a cross-sectional area of an end of a discharge glass tube that is to be mounted thereto, and the flare 110 is manufactured such that its cross-sectional area is reduced for a predetermined length from the upper surface towards a lower end, thus having the shape of a trumpet tube.

Further, the lead-in wire 130 and the exhaust tube 150 pass through the flare 110, thus providing a stem 100. During the manufacture of the stem 100, a pinch sealing process of securing the lead-in wire 130 and the exhaust tube 150 to the flare 110 is performed at the middle portion of the flare 110. This will be described in more detail with reference to other embodiments.

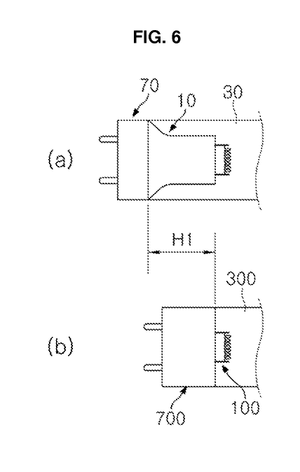

Once the stem 100 has been finished, a filament 500 is connected to an end of the lead-in wire 130 of the stem 100 to be seated thereto. In a direction where the filament 500 is inserted into the glass tube 300, the upper surface of the stem 100 is molten to be joined to the end of the glass tube 300 in a sealing manner. Particularly, in the joining and sealing process of the stem 100 and the glass tube 300, a body of the stem 100 is not inserted into the glass tube 300 but is located outside the glass tube 300, and only the filament 500 and a portion of the lead-in wire 130 supporting the filament 500 are inserted into the glass tube 300, so that a space in the glass tube 300 occupied by the stem 100 is eliminated. This will be also described in more detail with reference to an embodiment shown in FIG. 6.

After the stem 100 has been mounted to the glass tube 300, the interior of the glass tube 300 is exhausted via the exhaust tube 150 of the stem 100 to create a vacuum. After the injection of a predetermined gas, a base 700 is assembled to surround the stem 100 through a basing process, thus providing the fluorescent lamp.

The present invention, operational advantages of the present invention and objects accomplished by the present invention will be described below with reference to the preferred embodiments of the present invention.

First, it is to be understood that terms employed herein are for the purpose of description of particular embodiments and not of limitation. Further, the singular forms may include plural referents unless the context clearly dictates otherwise. Furthermore, it should be understood that terms “include” or “have” are inclusive of characteristics, numerals, steps, operations, components, parts or combination thereof, which are described herein, but are not exclusive of one or more different characteristics, numerals, steps, operations, components, parts or combination thereof.

When it is determined that the detailed description of the known art related to the present invention may obscure the gist of the present invention, the detailed description will be omitted.

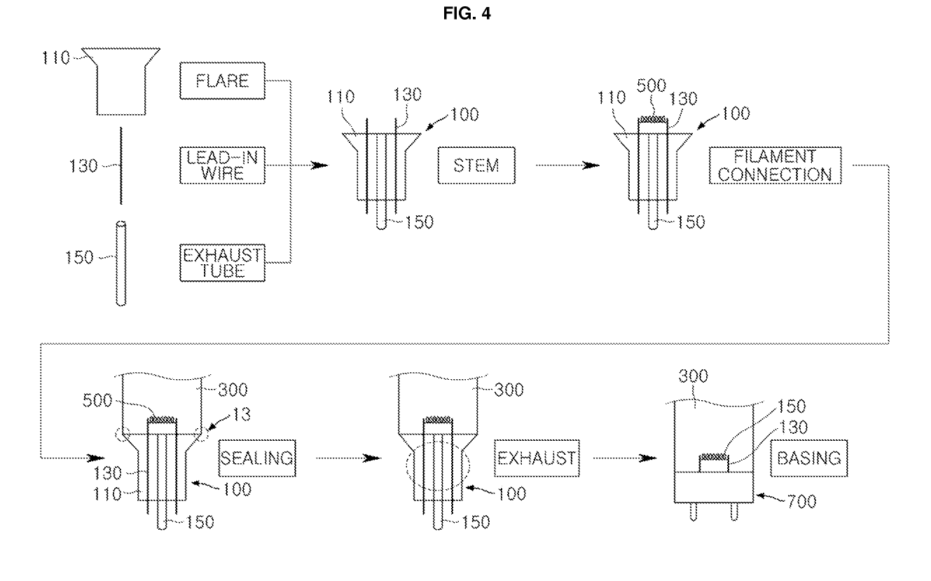

FIG. 4 is a view showing a fluorescent lamp according to an embodiment of the present invention.

The fluorescent lamp according to the embodiment of the present invention shown in FIG. 4(a) is also configured such that the filament 500 inserted into the discharge glass tube 300 is supported by the lead-in wire 130, and the base 700 is mounted to the end of the glass tube 300 to transmit external power to the filament 500.

The characteristic configuration of the present invention will be described with reference to FIG. 4(b) that is a sectional view of FIG. 4(a). The fluorescent lamp of the present invention mainly includes the stem 100 supporting the discharge glass tube 300 and the filament 500, and the base 700 applying external power. In this respect, the stem 100 is not inserted into the glass tube 300 but is coupled to the end of the glass tube 300 to be located outside the glass tube 300.

The stem 100 includes the flare 110 in which the lead-in wire 130 for supporting the filament 500 and the exhaust tube 150 for creating a vacuum in the discharge glass tube 300 are formed. The flare 110 is coupled to the glass tube 300 in a contact sealing manner. For the contact sealing, the upper surface of the flare 110 is formed to correspond to the cross-sectional area of the end of the glass tube 300, so that the upper surface of the flare 110 is sealed to the end of the glass tube 300. Preferably, the flare may have the shape of a trumpet such that its cross-sectional area is reduced for a predetermined length from the upper surface of the flare 110 to the lower end thereof. Further, the base 700 is mounted to surround the stem 100 installed outside the glass tube 300.

The fluorescent lamp according to the present invention is characterized in that the body of the stem 100 is located outside the discharge glass tube 300 and only the filament 500 and a portion of the lead-in wire 130 for supporting the filament 500 are inserted into the discharge glass tube 300.

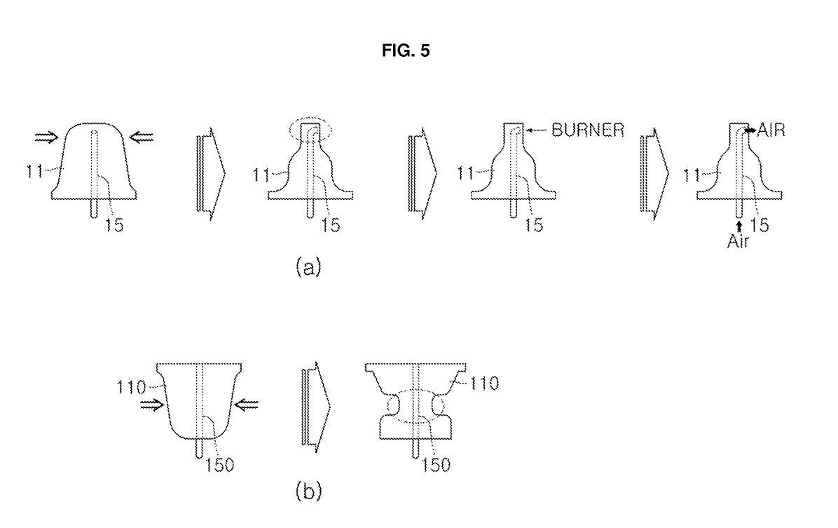

A pinch sealing process for the stem according to the present invention will be described in more detail. FIG. 5 is a flow diagram comparing a conventional process of securing an exhaust tube to a flare with a process of securing an exhaust tube to a flare according to an embodiment of the present invention.

FIG. 5 shows a portion of the stem manufacturing process. Although the lead-in wire is not shown to more clearly illustrate the process of forming the exhaust tube on the flare, the lead-in wire is formed together with the exhaust tube in the actual process. In order to make the characteristics of the present invention be more easily understood, the present invention will be compared with the prior art.

First, as for the prior art, as shown in FIG. 5(a), after the exhaust tube 15 and the lead-in wire are formed in the flare 11 having the shape of a bell, a lower end of which is wider than an upper portion. The upper end of the flare 11 is heated by a burner to be pinch sealed, thus fixing the exhaust tube 15 and the lead-in wire in the flare 11. In this case, a portion of the exhaust tube 15 that is pinch sealed to the flare 11 may be undesirably blocked. Thus, in order to clear the exhaust tube 15, air is injected through the exhaust tube 15 while the upper end of the flare 11 that is pinch sealed is additionally heated by the burner. Consequently, the exhaust tube 15 is cleared.

Further, as the pinch sealing process is performed by applying heat to the upper end of the flare 11, the lead-in wire protruding to the outside is subjected to heat and thereby is oxidized, so that the lead-in wire may be severely cut.

FIG. 5(b) shows a portion of the stem manufacturing process according to the present invention. After the exhaust tube 150 and the lead-in wire are formed in the flare 110 having the shape of the trumpet, the upper end of which is wider than the lower end, the middle portion of the flare 110 is heated by the burner to be pinch sealed, thus fixing the exhaust tube 150 and the lead-in wire in the flare 110.

Such a process of the present invention heats the middle portion of the flare 110, so that the exhaust tube 150 is scarcely blocked. Preferably, in order to reduce the blockage of the exhaust tube 150 to a greater extent, prior to performing the pinch sealing process, a metal pipe is inserted into the exhaust tube 150 and thereafter a heating process is carried out. Alternatively, the heating process is carried out while gas is continuously injected into the exhaust tube 150, thus preventing the exhaust tube 150 from being blocked. In addition, after the interior of the exhaust tube is coated using an insulation material, such as ceramic powder, which is higher in melting point than glass, the heating process can be performed.

Further, since the stem manufacturing process according to the present invention shown in FIG. 5(b) heats the middle portion of the flare 110, the lead-in wire is not directly exposed to the fire, thus preventing the lead-in wire from being oxidized and preventing the lead-in wire from being cut.

Next, the contact-sealing process of the discharge glass tube and the stem according to the present invention will be described. FIG. 6 is a flow diagram comparing a conventional process of sealing a glass tube and a stem with a process of sealing a glass tube and a stem according to an embodiment of the present invention

FIG. 6(a) shows the conventional process of sealing the glass tube and the stem. According to the prior art, heat is applied to a circumference of the lower end of the flare 11 of the stem 10 and the body of the stem 10 itself is inserted into the glass tube 30, so that the end of the glass tube 30 and the lower end of the flare 11 of the stem 10 are sealed, and consequently, the glass tube 30 is coupled to the stem 10.

In comparison to the prior art, FIG. 6(b) shows the process of sealing the glass tube and the stem according to the present invention. According to the present invention, heat is applied to a circumference of the upper end of the flare 110 of the stem 100 and the end of the glass tube 300 and the upper end of the flare 110 of the stem 100 are contact sealed so that only the filament 500 and a portion of the lead-in wire 130 supporting the filament 500 are inserted into the glass tube 300, and thereby the glass tube 300 is coupled to the stem 100. That is, according to the present invention, the body of the stem 100 itself is located outside the glass tube 300.

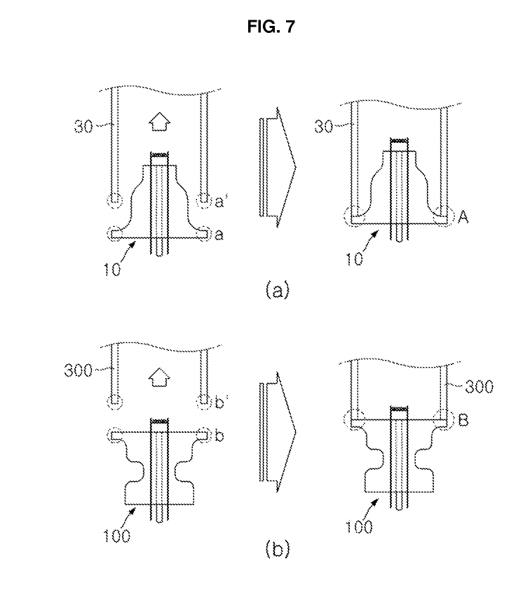

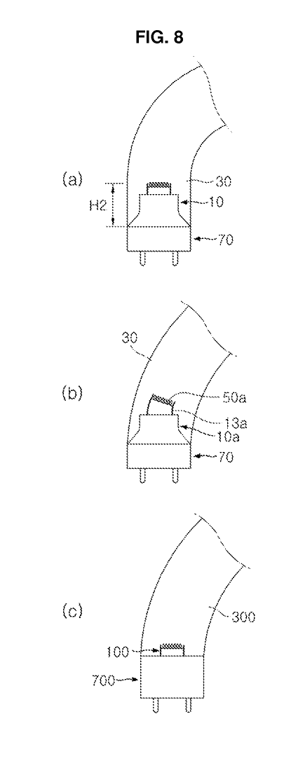

Due to the stem configured according to the present invention, this invention can provide the fluorescent lamp that can realize a substantially full spiral type lamp, reduce the manufacturing cost of the lamp, and decrease the use of the pollutant. This will be described with reference to FIGS. 7 and 8 in comparison to the prior art.

FIG. 7 is a view comparing a length of a conventional fluorescent lamp with a length of a fluorescent lamp according to an embodiment of the present invention. When comparing the length of the discharge glass tube of the conventional fluorescent lamp shown in FIG. 7(a) with that of the discharge glass tube of the fluorescent lamp according to the present invention shown in FIG. 7(b), the body of the stem 10 is inserted into the glass tube 30 and thereby the glass tube 30 requires an additional length corresponding to a length occupied by the stem 10 as for FIG. 7(a), but the body of the stem 10 is located outside the glass tube 300 and thereby a length of the glass tube 300 occupied by the stem 100 is not required as for FIG. 7(b).

In other words, assuming that the body of the stem 100 has the length of H1 or less, according to the present invention, the length of the glass tube 300 can be reduced from an end of the fluorescent lamp by H1, so that the length of the glass tube 300 can be entirely reduced from both ends of the fluorescent lamp by 2xH1. Even though the length of the fluorescent lamp is reduced, luminous efficiency is not varied.

According to the present invention, the stem is located outside the discharge glass tube to relatively reduce the length of the glass tube while maintaining the same luminous efficiency and thereby using a smaller amount of fluorescent substance in agreement with the reduced length, thus reducing the manufacturing cost of the lamp and decreasing the use of pollutants.

Further, the stem structure according to the present invention can realize a substantially full spiral type lamp. FIG. 8 is a view showing a conventional spiral type fluorescent lamp and a spiral type fluorescent lamp according to an embodiment of the present invention.

As for the conventional spiral type fluorescent lamp shown in FIG. 8(a), the body of the stem 10 is inserted into the glass tube 30, so that it is impossible to bend a predetermined portion of the glass tube 30 connected to the base 70, but only a portion of the glass tube 30 subsequent to a straight section corresponding to the length H2 of the body of the stem 10 may be made in a curved form.

In order to solve the problem, a method of bending the lead-in wire supporting the filament at a predetermined angle or inserting the stem itself into the glass tube at a predetermined angle has been proposed. As for the conventional half spiral type fluorescent lamp shown in FIG. 8(b), it is a short leg half spiral type fluorescent lamp. The straight portion of the end of the glass tube 30 into which the stem 10a is inserted is formed short to have a length of about 10 mm. Further, in order to prevent the filament 50a from being in contact with a surface of the glass tube 30 while the stem 10a is inserted into the short straight section, the lead-in wire 13a supporting the filament 50a is bent at a predetermined angle. This is problematic in that it is not easy to locate the filament 50a in a central portion of the glass tube 30, it is difficult to automate the process of manufacturing the lamp, and above all, the manufacture of defective products with filaments in contact with the wall of the glass tube 30 may occur frequently.

In contrast, as for the spiral type fluorescent lamp according to the present invention shown in FIG. 8(c), the body of the stem 100 itself is located outside the glass tube 300, and only the filament and a portion of the lead-in wire for supporting the filament are inserted into the glass tube 300, so that the bending operation is possible starting from the end of the glass tube 300 connected to the base 700 without forming the straight section, and thereby a full spiral type fluorescent lamp can be obtained.

In the general stem, the lead-in wire and the filament are installed in the straight line. For this reason, after the lead-in wire is bent to mount the stem to the spiral type discharge glass tube, the stem is inserted not along a straight track but along a curved track. Thus, operating efficiency is deteriorated, and the position of the filament is inaccurate, so that a defective product may occur. However, according to the present invention, since the filament is not inserted deeply from the end of the glass tube, it is unnecessary to bend the lead-in wire. Further, since it has only to mount the stem to the glass tube in a straight line, the lamp manufacturing process can be easily automated.

As described above, the present invention provides a method of manufacturing a fluorescent lamp and a fluorescent lamp manufactured using the same, in which a flare of a stem is located outside a discharge glass tube, and only a filament and a portion of a lead-in wire for supporting the filament are inserted into the discharge glass tube, thus eliminating a space in the glass tube occupied by a body of the stem and allowing a substantially full spiral type lamp or a short leg half spiral type lamp to be easily implemented.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. It is thus understood that the foregoing embodiments are illustrative and not restrictive, and the embodiments are not intended to limit the technical scope of the present invention. Also, the scope of the present invention is defined by the appended claims, and all changes that fall within meets and bounds of the claims, or equivalences of such meets and bounds are embraced by the invention.

What is claimed is:

1. A method of manufacturing a fluorescent lamp, comprising:
preparing a flare having an upper surface that corresponds to a cross-sectional area of a glass tube of the lamp;
manufacturing a stem by forming a lead-in wire and an exhaust tube that pass from a lower surface of the flare to the upper surface thereof, and connecting a filament to the lead-in wire of the stem; and
melting a circumference of the upper surface of the flare of the stem, introducing the filament into the glass tube via an opening thereof, and contact sealing the upper surface of the flare to an end of the glass tube in such a way that the stem is located outside the glass tube.

2. The method of claim 1, wherein the manufacturing the stem comprises:
forming the lead-in wire and the exhaust tube in such a way as to pass from the lower surface of the flare to the upper surface thereof;
heating and pinch sealing a middle portion of the flare; and
connecting the filament to the lead-in wire of the stem.

3. The method of claim 2, wherein at the preparing the flare, the flare is manufactured such that a cross-sectional area thereof is reduced for a predetermined length from the upper surface of the flare to a lower end thereof.

4. The method of claim 2, wherein at the pinch sealing, after a metal pipe is inserted into the exhaust tube, the middle portion of the flare is heated to be pinch sealed.

5. The method of claim 2, wherein at the pinch sealing, while gas is injected into the exhaust tube, the middle portion of the flare is heated to be pinch sealed.

6. The method of claim 2, further comprising:
evacuating the glass tube through exhaust tube to create a vacuum in the glass tube, injecting a predetermined gas, and then assembling a base to surround the stem.

7. A fluorescent lamp with a stem, comprising:
a flare coupled at an upper surface thereof to an end of a glass tube through contact sealing in such a way that a body of the flare protrudes out from the glass tube;
a lead-in wire passing from a lower surface of the flare to an upper surface thereof to support the filament located in the glass tube; and
a stem including an exhaust tube that passes from the lower surface of the flare to the upper surface thereof.

8. The fluorescent lamp of claim 7, further comprising:
a base provided to surround the stem.

9. The fluorescent lamp of claim 7, wherein the fluorescent lamp is a full spiral type fluorescent lamp.

10. The fluorescent lamp of claim 7, wherein the fluorescent lamp is a half spiral type fluorescent lamp.
